(19) United States
(12) Patent Application Publication
(10) Pub. No.: US 2004/0085670 A1
(43) Pub. Date: May 6, 2004

(54) Method for measuring pad wear of padded slider with MRE cooling effect

(75) Inventors: Xinwei Li, San Jose, CA (US); Huan Tang, Los Altos, CA (US); Jing Gui, Fremont, CA (US)

Correspondence Address: Kirk A. Cesari, Seagate Technology LLC, 1280 Disc Drive, Mail Stop SHK2LG, Shakopee, MN, 55379-1863, US

(73) Assignee: Seagate Technology LLC, Scotts Valley, CA

(21) Appl. No.: 10/425,996

(22) Filed: Apr. 29, 2003

Related U.S. Application Data
(60) Provisional application No. 60/424,160, filed on Nov. 5, 2002.

(51) Int. Cl. G11B 21/02; G11B 27/36

(52) U.S. Cl. 360/75; 360/31

(57) ABSTRACT

Disclosed is a method measuring the height of a magneto-resistive element (MRE) on a padded slider in a disc drive based on a change in the resistance of the MRE. During operation of the disc drive a biasing current is applied to the MRE head. Next a resistance value of the MRE head is calculated by determining the voltage drop across the MRE head. The resistance of the MRE head is dependent upon its temperature. The temperature of the MRE lowers as its proximity to the disc increases, as the cooler disc surface acts as a conduit drawing heat away from the MRE. This measured resistance value is compared to a threshold value. The threshold value is based upon the resistance of the MRE head at a threshold temperature, which corresponds to a specific distance away from the disc surface. If the measured resistance is lower than the threshold resistance the method outputs an indication to a user that the drive is in danger of failing.

### CROSS-REFERENCE TO RELATED APPLICATION

This application claims priority from U.S. Provisional Application 60/424,160 filed on Nov. 5, 2002 for inventors Xinwei Li, Huan Tang and Jing Gui and entitled METHOD FOR MEASURING PAD WEAR OF PADDED SLIDER WITH MRE COOLING EFFECT.

### FIELD OF THE INVENTION

The present invention relates generally to disc head sliders for use in disc drives, and more particularly but not by limitation to determining if the disc drive may experience failure due to disc head tipping or excessive pad wear.

### BACKGROUND OF THE INVENTION

Disc drives use rigid discs, which are coated with a magnetizable medium for storage of digital information in a plurality of circular, concentric data tracks. The discs are mounted on a spindle motor, which causes the discs to spin and the surfaces of the discs to pass under respective hydrodynamic (e.g., air) bearing disc head sliders. The sliders carry transducers, which write information to and read information from the disc surfaces.

An actuator mechanism moves the sliders from track-to-track across the surfaces of the discs under control of electronic circuitry. The actuator mechanism includes a track accessing arm and a suspension for each head gimbal assembly. The suspension includes a load beam and a gimbal. The load beam provides a load force which forces the slider toward the disc surface. The gimbal is positioned between the slider and the load beam, or is integrated in the load beam, to provide a compliant connection that allows the slider to pitch and roll and assume an orientation relative to the disc that balances the hydrodynamic forces that support the slider.

The slider includes a bearing surface, which faces the disc surface. As the disc rotates, the disc drags air under the slider and along the bearing surface in a direction approximately parallel to the tangential velocity of the disc. As the air passes beneath the bearing surface, air compression along the air flow path causes the air pressure between the disc and the bearing surface to increase, which creates a hydrodynamic lifting force that counteracts the load force and causes the slider to lift and fly above or in close proximity to the disc surface.

With contact start-stop drives, the sliders are parked in predetermined landing zones during the start and stop of disc rotation. The traditional CSS (contact start-stop) interface at the landing zone is formed by a rough, textured disc surface and a smooth slider air-bearing surface (ABS). The textured disc surface reduces stiction and friction forces during contact start and stop by reducing the area of contact between the slider and the disc surface. This is often accomplished by means of mechanical or laser texture. This type of interface has provided sufficient durability when the fly height of the slider is high, on the order of a few microinches. However, the fly height, which is a major part of the head-media magnetic spacing, has been aggressively reduced to sub microinches to support the continuously increasing magnetic recording density.

Lowered fly heights increase wear stress levels and hence decrease the durability of the head-disc interface. The traditional CSS interface fails to provide enough durability without introducing excessive stiction and friction in low fly height regimes. One solution is to transfer at least a portion of the texture from the disc to the slider. This led to the development of the padded slider in order to reduce the head disc interaction and to control friction and stiction during contact start and stop.

Prior to rotation of the disc, the slider rests on the disc surface. The slider is not lifted from the disc until the hydrodynamic lifting force, caused by rotation of the disc, is sufficient to overcome a preload force supplied by the suspension to bias the slider toward the disc surface, and a stiction force holding the slider to the disc surface. The hydrodynamic properties of the slider are affected by the speed of rotation of the disc, the design of the air bearing surface of the slider, and the preload force supplied to the slider via the suspension assembly.

Typically a lubricant coating covers the disc surface to protect the slider and disc from wear during contact starts and stops (CSS). Contact between the slider and disc surface (and lubricant coating) creates a meniscus effect which increases stiction force between the slider and disc surface. When a disc drive is turned on, the spindle motor produces torque to overcome stiction and initiate “spin-up”. Stiction increases the motor torque required to spin-up the disc drive. If stiction is too large for motor torque to overcome, spin-up failure could occur.

In a typical padded slider, the rear-most pads are positioned away from the slider trailing edge by an adequate amount such that the pads not to protrude below the plane defined by the read/write elements during flying, given the pitch angle of the slider during flight. However, this arrangement of the pads in relation to the head occasionally permits the head to tip backwards and come to rest on the disc in a tipped state, i.e., resting on its rear-most pads and the ABS trailing edge, when the disc oscillates back and forth slightly during power down. This tipping arrangement can lead to stiction failure as large, high-pressure menisci can form underneath the non-padded portion of the air-bearing surface near the trailing edge. The occurrence of head tipping, has been indirectly verified in backward-forward disc rotation experiments and head foot print on a heavily lubed disc surface.

During tipping the tipping stiction may easily exceed 20 grams, especially following a prolonged resting period. In normal operation, possibly one of the sliders will be in a tipped state when the discs are at rest. The spindle motor is generally capable of spinning the disc up and overcoming the stiction force associated with the tipping of one slider. However, when more than one of the sliders in the disc stack is tipped it may be impossible for the spindle motor to overcome the associated stiction forces. Prolonged resting of the head on the disc can also lead to significantly higher stiction values above the short-dwell non-tipping stiction baseline. There is a general lack of capability to monitor the resting state of the head in a typical CSS test. Therefore, it is highly desirable to devise a method to monitor a padded slider's resting state during CSS.

Embodiments of the present invention provide solutions to these and other problems, and offer other advantages over the prior art.

### SUMMARY OF THE INVENTION

One embodiment of the present invention is directed to a method for measuring the height of a magneto-resistive element (MRE) on a padded slider in a disc drive based on a change in the resistance of the MRE. The detection system calculates the resistance of the MRE head in a normal resting position. This value is then stored for use later by the system. During operations a biasing current is applied to the MRE head. This biasing current can be applied prior to disc spin-up or during disc shut down. Next a resistance value of the MRE head is calculated by determining the voltage drop across the MRE head. The resistance of the MRE head is dependent upon its temperature. The temperature of the MRE lowers as its proximity to the disc increases, as the cooler disc surface acts as a conduit drawing heat away from the MRE. This measured resistance value is compared to a threshold value. The threshold value is based upon the resistance of the MRE head at a threshold temperature, which corresponds to a specific distance away from the disc surface. This distance is a height that indicates that head is too close to the surface of the disc. If the measured resistance is lower than the threshold resistance the method outputs an indication to a user that the drive is in danger of failing. In an alternative embodiment, the method calculates the resistance value for the heads in a disc stack, and provides an output only if a threshold number of the heads exhibit the lowered resistance.

A second embodiment of the present invention is directed towards a system for detecting head failure in a padded slider. The system monitors the height of the MRE head above the disc surface by measuring the resistance of the MRE head during disc spin-up or disc shut down. The MRE head has a resistance that is thermally dependent, and the resistance of the MRE head reduces as the head approaches the surface of the disc due to a cooling effect caused by the disc surface. The system includes a biasing current generator, a voltage measuring component, a processor, and an output component. The biasing current generator is configured to provide a biasing current to the MRE head. This biasing current causes the MRE head to heat, and thus change its resistance. The voltage measuring component is configured to measure a voltage drop across the MRE head in response to the biasing current. The processor is configured to determine the resistance of the MRE head based upon the measured voltage drop, and is configured to compare the resistance with a threshold resistance. The threshold resistance is a resistance that is lower than the resistance of the MRE head when in a normal position. The output component generates an output to a user indicating possible drive failure if the resistance of the MRE is lower than the threshold resistance.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive according to one embodiment of the present invention.

FIG. 2 is a bottom plan view of a slider having a padded air bearing surface.

FIG. 3A is a profile view of a slider in a normal resting position relative to a disc surface.

FIG. 3B is a profile view of a slider in a tipped position relative to the disc surface.

FIG. 4 is a block diagram of a monitoring system according to one embodiment of the present invention.

FIG. 5 is a graph illustrating an exemplary MRE resistance response curve and an associated friction-heating curve.

FIGS. 6A and 6C are friction and MRE resistance traces protect from a transducer on a slider in a normal non-tipped state.

FIGS. 6B and 6D are friction and MRE resistance traces protect from a transducer on a slider in a tipped state.

FIG. 7 is a chart illustrating a relationship between MRE cooling and stiction.

FIG. 8 is a flow diagram illustrating the steps executed by the monitoring system of FIG. 4.

### DETAILED DESCRIPTION OF ILLUSTRATIVE EMBODIMENTS

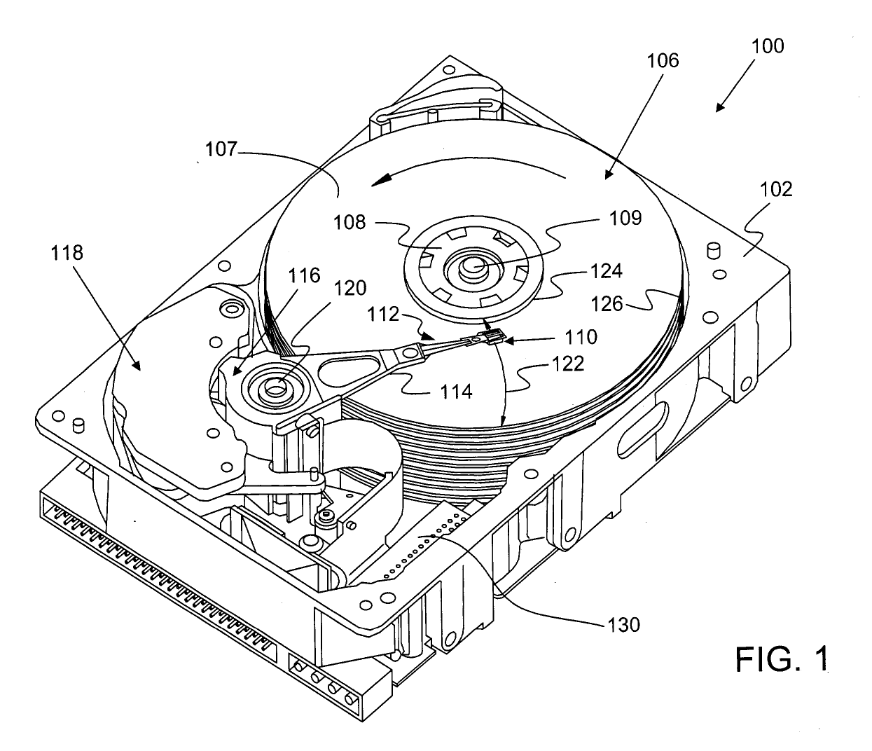

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

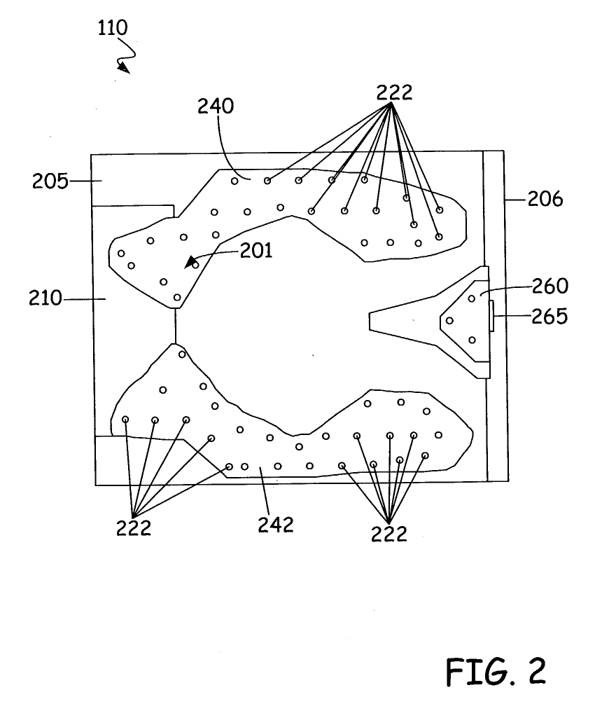

FIG. 2 is a bottom plan view of slider 110 with which the present invention can be used. Slider 110 is formed of a rigid member including a leading edge 205, a trailing edge 206, and an air bearing surface 201. The air bearing surface 201 of the slider 110 faces the disc surface and includes raised side rails 240 and 242, and a center pad or rail 260, for example. Slider 110 also includes a step surface 210 and a subambient pressurization cavity 220. The subambient pressurization cavity 220 is bounded by the trailing edge 211 of the step surface 210 and the side rails 240 and 242. Center pad 260 supports a transducer 265 (illustrated diagrammatically) for read or write operations. Transducer 265 may include any type of read write transducer, such as an inductive, magnetoresistive, optical or other type of resistor. The slider 110 includes a plurality of pads 222 or SLIP (Slider Landing Integrated Pad) extending from the bearing surface to support the slider above the disc surface for contact starts and stop. Although a particular bearing surface is illustrated in FIG. 2, it will be understood by those skilled in the art that alternate bearing designs may be used and application is not limited to a particular bearing design.

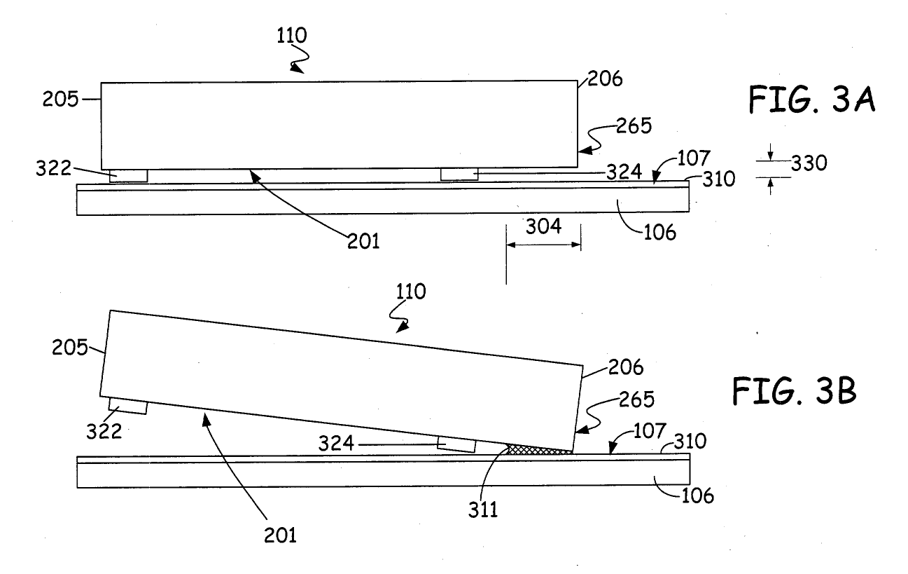

A simplified arrangement of these pads is illustrated in FIGS. 3A and 3B by pads 322 and 324. In the embodiment illustrated, landing pads 222 extend from, or are elevated above the bearing surface 201 and proximate to the leading and trailing ends 205, 206, respectively to support the slider 110 above the disc surface 107 for CSS.

In operation, rotation of the discs 106 in FIG. 1 create a fluid or air flow under each bearing surface 201 from the leading edge 205 toward the trailing edge 206 which raises each slider 110 above the disc surface. Pads 322 and 324 have heights and locations that are designed such that the pads do not interfere with the flying height of the slider 200 at the trailing edge 206.

Sufficient lift must be imparted to the bearing surface 201 to overcome the stiction holding each slider 110 to the disc surface and the preload force supplied by the suspension assembly. During disc spin-up the motor torque of the spindle motor must overcome the stiction forces holding the sliders to the disc surfaces. If there is too much stiction between the sliders 110 and the discs, the spindle motor may not be able to overcome the stiction forces which can lead to drive failure. Excessive stiction forces can be caused by a single head or by a combination of the stiction force experience by all of the sliders in the disc stack.

FIGS. 3A and 3B are side plan views of one of the slider 110 supported over a disc surface 107 FIGS. 3A and 3B illustrate a simplified representation of pads 222 (shown in FIG. 2) in which individual pads 322 and 324 are shown. Pads 322 and 324 extend below bearing surface 201 toward disc surface 107 to support slider 110 on disc surface 107 and lubricant film layer 310 when disc 106 is not rotating.

Sliders typically fly above the disc surface 107 at a pitch angle so that the trailing edge 206 supporting the transducer elements flies closer to the disc surface than the leading edge 205. A real disc drive density is increasing and slider fly height is decreasing for desired read or write resolution. As illustrated in FIG. 3A, pads 324 are spaced a distance 304 from the transducer 265 and the trailing edge 206 to limit contact interference between the pad 324 and the disc surface 107 during the rotation of disc 106. However, the position of pad 324 increases the propensity of the slider to tip during spin down so that trailing edge contacts or touches the lubricant film 310 on the disc surface 107 as illustrated in FIG. 3B.

In particular, in FIG. 3B, a trailing edge portion 206 of the slider 110 spaced from pad 324 tips toward the disc surface to contact the lubricant film layer 310. Interface between the slider surface and lubricant film layer 310 creates meniscus 311 between the lubricant film layer 310 and slider 110. Interaction between the slider 110 and the lubricant film layer 310 has been confirmed experimentally.

Meniscus 311 is formed when the lubricant 310 is dragged from the contact area between the slider and disc surface along the surface of the slider (herein capillary surface), via capillary pressure. The lubricant film is dragged so that the effect of the meniscus expands, while the attractive force between lubricant molecules and the solid surface, which can be quantitatively represented by the disjoining pressure of the lubricant film, is overcome by the driving force of the capillary pressure of the meniscus. The magnitude of the meniscus force and stiction for the slider is proportional to the area of the meniscus. If the additional stiction forces caused by one or more of the tipped heads is large enough the stiction forces can stop the spindle motor from spinning up the discs 106 causing the loss of data stored on the discs.

The formation of a large meniscus, and therefore a large sitction, as the discs stops rotating usually takes several seconds or longer. If the drive can detect the onset of the tipping within a fraction of a second, and then perform some action to break the tipping, the drive could avoid a stiction failure, as mentioned above. Head tipping usually is induced by a backward rotation of the disc prior to its coming to a complete stop at the end of CSS cycle. Since the exact movement of the drive motor prior to stopping is uncontrolled and is usually random, tipping usually occurs as a stochastic event. By simply restarting the drive motor or using other methods to move the disc forward and allowing it to stop again, the head may not end up in a tipped state. This solution is possible because when the head just tips, within a fraction of a second the meniscus is still small, and therefore, a drive motor will have enough torque to break the tipping stiction.

Another difficulty experienced with padded sliders, such as illustrated in FIGS. 2, 3A and 3B, is wear of pads over time. With such padded slider design, all the wear and tear of the head is concentrated on the pads, especially the trailing edge pads (e.g. 324) which have much longer contact time with the media during take off and landing. The wear of the pads is often significant, leading to contact of the transducer 265 with the disc surface 107 causing a “head crash”. Head crash is a catastrophic failure leading to data loss.

One embodiment of the present invention is directed to a method and apparatus for measuring pad wear during disc drive operation. By measuring pad wear, pad wear related drive failure can be predicted and thus data can be saved before any actual failure, and the drive can be replaced before the actual failure.

It has been found that pad wear and head tipping can be measured by monitoring the distance of the read/write transducer and the disc surface during CSS operations, or alternatively when the discs are at rest. For example, the inventors of the present invention have found a direct correlation between a cooling effect of an MRE head and the distance between the MRE head and the disc surface. The MRE cooling effect can be used to detect both head tipping and excessive pad wear, since as the MRE head comes closer to the disc surface in each circumstance. The MRE has a higher temperature than the ambient environment, including the disc, when a current is passing through it. The final temperature of the MRE element depends on the balance between heating and cooling. Heating includes electrical current heating an friction heating. Cooling includes thermal radiation and conduction through the disc and surrounding air. The proximity of the hot MRE element to the cool disc surface has very significant contribution to the cooling rate. When the MRE element is closer to the disc surface, the temperature drop can be detected through the drop in its electrical resistance.

The thermal coupling effect of a MRE, and notably the thermal asperity effect, is well known in MR head applications. The resistance of the MRE, which responds to magnetic field changes, is also sensitive to temperature changes, with a sensitivity of approximately 0.3%/° C. When the MRE is activated with a biasing current its temperature is raised substantially above the ambient environment. Generally the biasing current is approximately 10 mA for normal operations. However, other biasing currents can be used. This increase in the temperature is determined by the rate of heat generation due to resistive heating and the rate of heat conduction away from the MRE. When a padded slider rests in its normal position, as illustrated in FIG. 3A, the distance 330 between the MRE and the disc surface is typically in the range of 250 angstroms (Å) to 500 Å. This height 330 is approximately equal to the height of the slider pads. However, other heights can be used. In this arrangement, the primary path for heat conduction away from the MRE is into the slider body 301 and the surrounding air. In a tipped state, such as illustrated by FIG. 3B, the MRE 265 is brought into close proximity with the disc surface 107. The distance between the MRE 265 and the disc surface 107 is illustratively reduced to less than approximately 50 Å. In tipped state, the disc 206 provides an additional path for conducting heat away from the MRE 265. The increased cooling of the MRE 265 in the tipped state compared with the un-tipped state results in a cooler MRE, and hence a lower resistance.

Therefore, one method to detect the onset of tipping is to use the MRE cooling effect, which directly measures the distance between the MRE, and already exists in the head serving as the reader, and the disc surface. By recording the tipping events and calculating the tipping probability, this method can identify drives having heads that are easy to tip and more likely to have stiction failure in the future. The implementation of this solution in a drive requires some relatively simply modification to the drive's electronics firmware and some new coding to the control system to sense the MRE resistance change, to determine if a tipping event has happened, and if so, apply a current pulse to the motor to move the motor to eliminate tipping. This sequence of actions should be repeated until the head stops and rests in an untipped state.

Early detection of drives that are developing tipping problems helps warn the user of possible drive failure and thus data back-up could be performed before the actual drive failure, and the drive replaced before the failure.

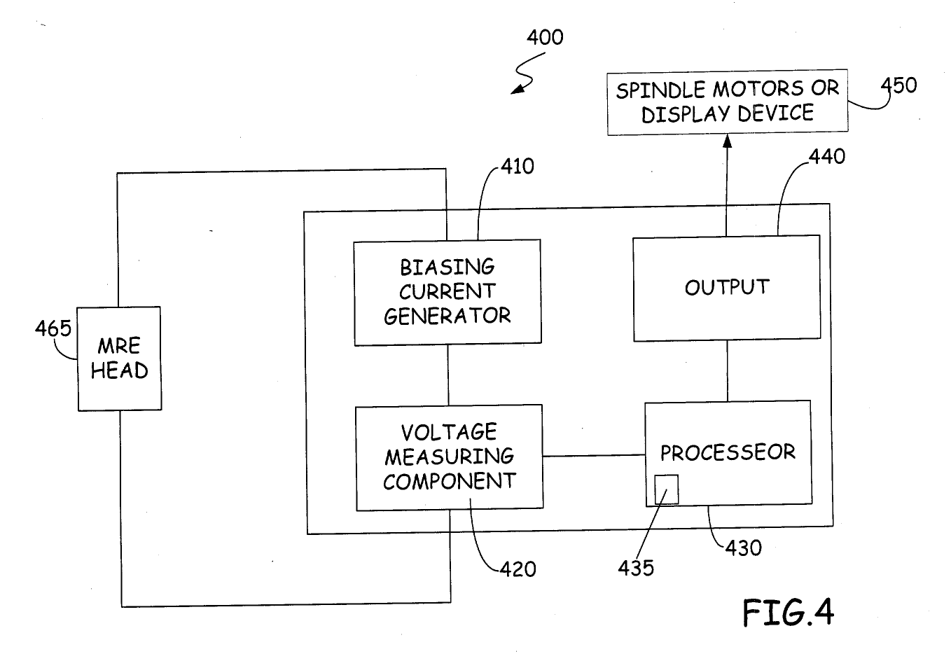

FIG. 4 is a block diagram of an MRE height monitoring system 400 that monitors the change in resistance of the MRE head according to one embodiment of the present invention. MRE height monitoring system 400 includes a current generator 410, a voltage-measuring component 420, a processor 430 and an output component 440.

To monitor the temperature or the resistance change during tipping, a constant test current is applied to heat the MRE 465 above the ambient temperature by the test current generator 410. This increase in temperature is illustratively about 30° C. In one embodiment, the test current applied by current generator 410 is approximately 5 milliamps. However, other current values can be used. Preferably, the applied test current is less than the operating current of the MRE 465 so as to reduce the risk of damaging the MRE 465 by thermal heating. Pad wear can be tested at the same time with the test current or during normal operation using the operating current.

The voltage drop across the MRE 465 is monitored continuously by voltage-measuring component 420. Voltage-measuring component 420 is configured to detect the resistance changes induced by heating or cooling of the MRE 465, and provides information regarding the changes to the processor 430. The MRE resistance is normalized to that of the normal head position (i.e. in the non-tipping position illustrated in FIG. 3A). Relative resistance changes are calculated by the processor 430 to remove initial MRE resistance variations among different heads. Processor 430 also stores in memory 435 the MRE resistance values for the MRE in the normal head position. Processor 430 compares the measured resistance with the resistance value stored in memory 435. If the resistance change exceeds a threshold value the processor causes an output to be generated by output component 440 indicated that a possible drive failure has occurred or is likely to occur. This threshold value is generally in the range of 0.1 to 0.3% of the baseline resistance. However, other threshold values can be used. The output can be output to a user display device, to the spindle motor, or other device, as indicated by block 450.

Monitoring system 400 can also be used to monitor pad wear over the life of the slider. When used to monitor pad wear the height monitoring system 400 measures the resistance of the MRE head 465 using the biasing test current generated by the current generator 410. This measured resistance is compared with the baseline resistance stored in memory 435. If the difference between the measured resistance and the baseline resistance exceeds a threshold value, processor 430 causes an output to be generated by output device 440 indicating to the user that a drive failure may be imminent and the drive should be replaced. In one embodiment the baseline resistance of the MRE 465 is approximately 50 ohms, and the threshold value is a 0.2% change in the resistance value. However, other resistance and threshold values can be used.

Typically pads on a padded slider range in height from between 250 Å and 300 Å. However, other heights can be used. Assuming that the original height of the pad is 300 Å, the threshold height for generating an output message is when the height of the pad has been reduced to approximately 250 Å. Of course other heights could be used as a threshold height. This reduction of height of approximately 50 Å corresponds with an approximate reduction in resistance of the MRE head 465 of 0.05%. However, the actual resistance value for each MRE head at the desired height can be calculated from experimental data, which is then stored in memory 435 and used as the threshold value.

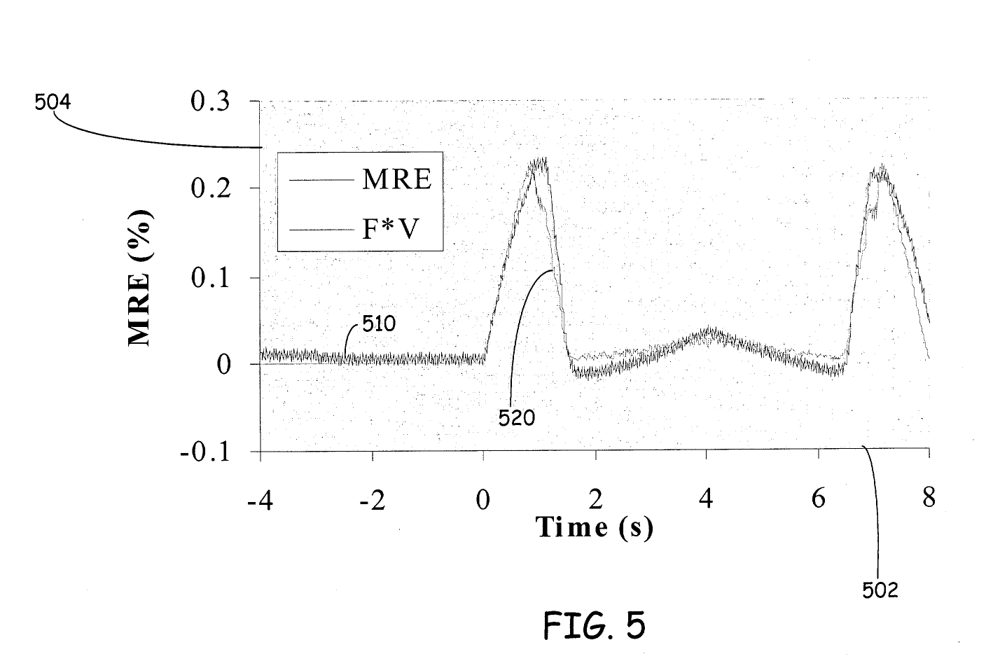

An exemplary MRE resistance response in a CSS cycle is illustrated in FIG. 5 along with an associated friction-heating curve. The x-axis 502 represents time, where t=0 represents the point when the disc is first spun-up, and the y-axis 504 represents the change in resistance of the MRE in percentage. The MRE resistance response curve 510 illustrates the change in resistance of the MRE in percentage versus time in seconds. The friction-heating curve 520 is simply a product of the friction (F) and the disc linear velocity (V) and is plotted versus time. The friction-heating curve 520 illustrated has been resized along the y-axis 504 to allow for easier comparison with the MRE resistance curve. The two curves 510 and 520 exhibit a remarkable resemblance to each other, and clearly indicates the thermal origin of the MRE resistance variations.

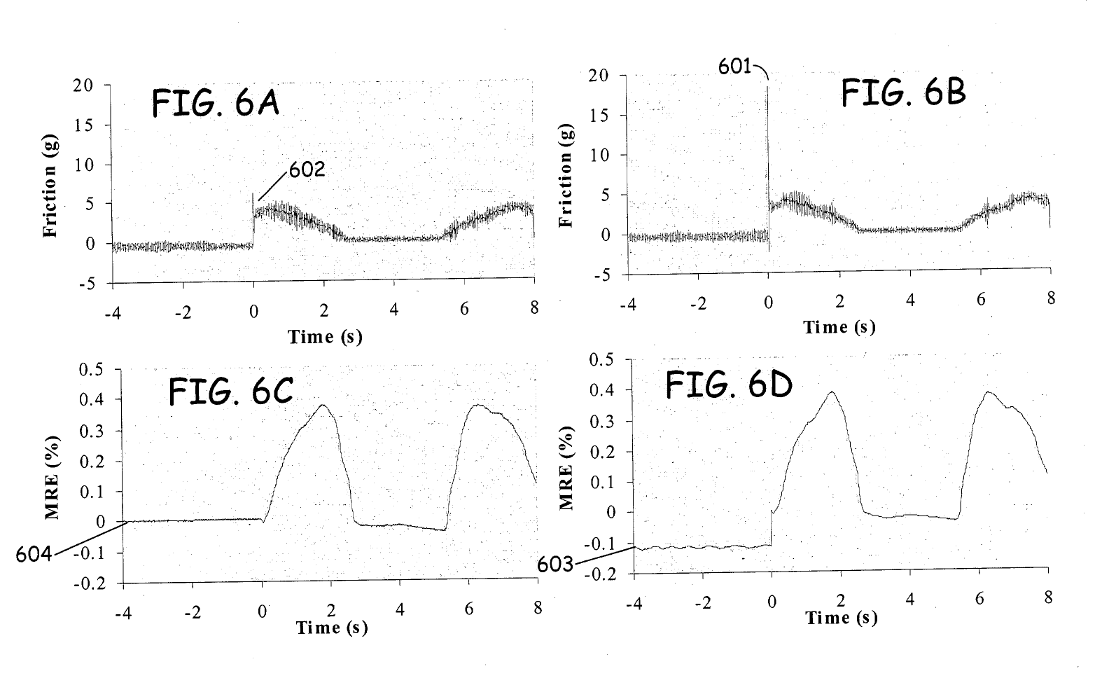

A padded slider, such as slider 110 illustrated in FIG. 2, which had shown the characteristic bi-modal large stiction in previous CSS tests, was tested again in CSS with MRE resistance sensing. The results of this test are illustrated in FIGS. 6A-6D.

The disc substrate of the tested slider was of super polished glass ceramic with a roughness (Ra) of about 4 Å. The disc was lubed with 16 Å of Z-tetraol. After a few hundred cycles, high stiction events began to occur, which were immediately recognized as due to head tipping, as illustrated in FIG. 6A. FIGS. 6A and 6C are friction and MRE resistance traces from a normal non-tipped state. FIGS. 6B and 6D are friction and MRE resistance traces from a tipped state.

In the friction traces, FIG. 6B has a much larger stiction peak than FIG. 6A. These peaks are illustrated by reference numbers 601 and 602, respectively. In the MRE resistance traces, FIG. 6D has a low starting value as referenced to a low RPM MRE resistance value, whereas FIG. 6B does not have such a low starting value, as illustrated by points 603 and 604, respectively. The sudden jump to zero in the MRE resistance in FIG. 6D at time zero, which is when the spindle starts to spin, is caused by the sudden un-tipping of the head due to forward spindle rotation. The low MRE resistance before CSS starts is a direct indication that the MRE sensor was very close to the disc surface, and the high stiction event is caused by tipping. The change in MRE resistance value from a tipped to an un-tipped state is quite small. The change in resistance is generally only about 0.1%. However, the change in resistance is much larger than the noise level in the measurement system. Therefore, the MRE cooling effect is capable of detecting head tipping unambiguously.

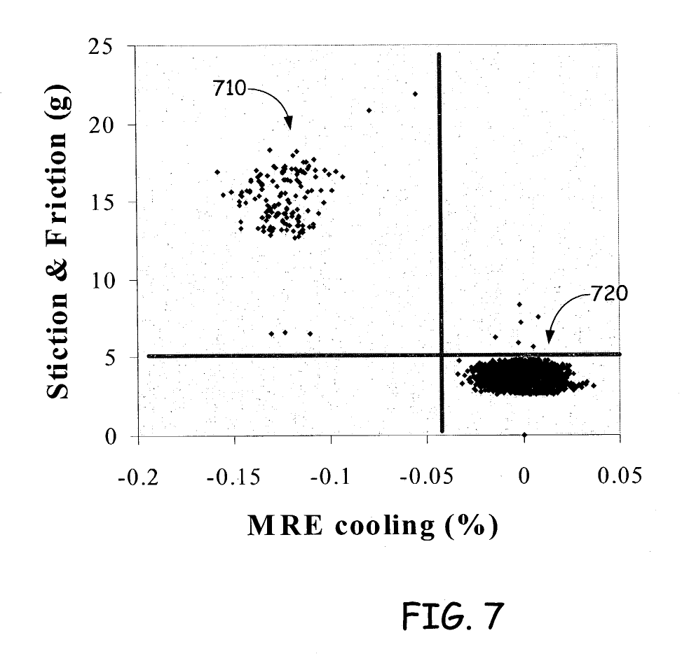

A good correlation among high stiction and MRE cooling in CSS tests are illustrated in FIG. 7. In this case, all of the high stiction events 710 are associated with MRE cooling, i.e. head tipping, and the low stiction events 720 are associated with dwell stiction. This correlation unambiguously illustrates the causal relationship between head tipping and high stiction values.

The MRE resistance sensing technique can be implemented into a disc drive using very simple electronics. Using the MRE resistance as a signature, the resting state of a padded slider on a disc for each CSS cycle can be readily and unambiguously determined. Specifically, when the padded slider rests in the normal state, the MRE resistance is comparable to the reference level defined as the resistance value at low-RPM sliding and changes smoothly from rest to sliding. In contrast, when the head rests in a tipped state, the MRE resistance is decreased by one to several tenths of a percent and abruptly jumps to a normal level at the beginning of sliding. By simultaneously monitoring the MRE resistance and a strain gauge signal, it was demonstrated that stiction failure is often preceded by head tipping, thus establishing head tipping as a root cause of stiction failure for the padded slider interface.

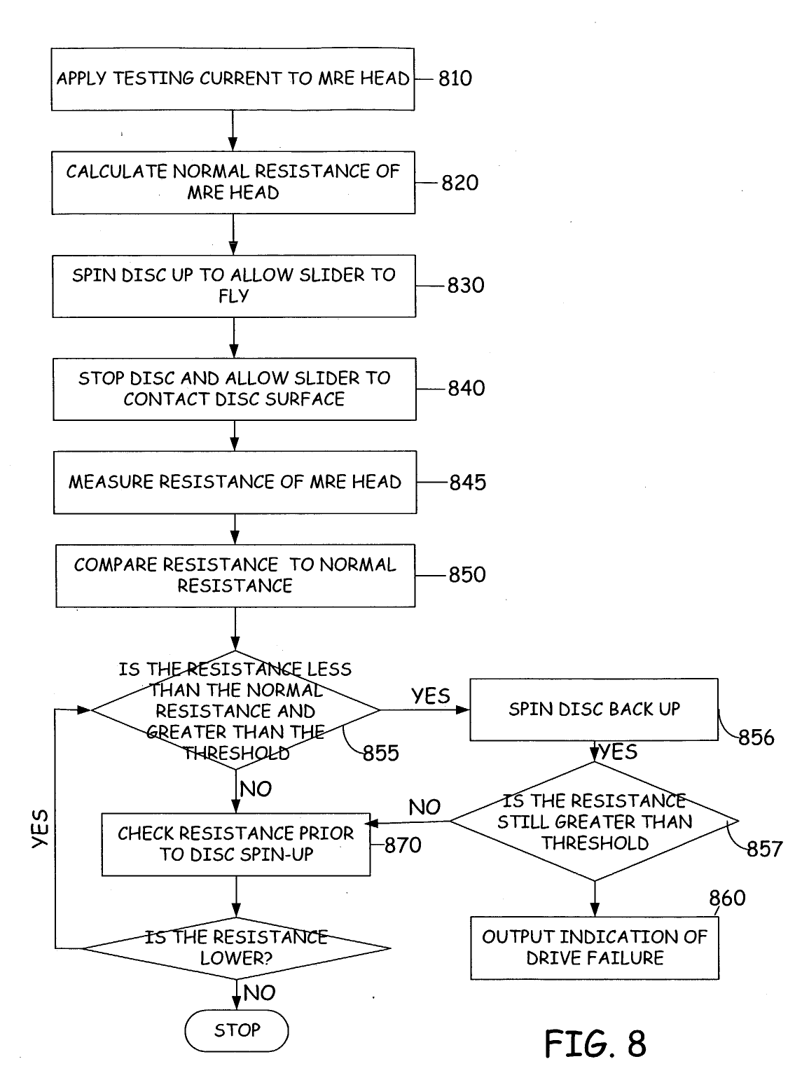

FIG. 8 is a flow chart illustrating an exemplary process executed by the monitoring system 400 in FIG. 4 to determine if the slider is tipping. However, as discussed above monitoring system 400 can also be used to monitor pad wear on the slider. At block 810, the system 400 applies a testing current to the MRE head 465 when the MRE head 465 is in a normal state resting on the surface of the disc. Monitoring system 400 then uses processor 430 to calculate the resistance for the MRE head, and stores this value in memory 412 as a baseline resistance. This resistance calculation occurs at block 820. The disc is then “spun-up” by the spindle or other means, and the slider is allowed to fly, at block 830. At block 840, the disc is stopped and the slider is allowed to contact the disc. At this time the height monitoring system 400 checks the resistance of the MRE head 465 at block 845. The measured resistance of the MRE head 465 is then compared to the baseline resistance, at block 850. Then the system 400 checks if the resistance of the MRE head 465 exceeded the threshold value at block 855. If the resistance of the MRE head 465 is lower than the baseline resistance and is beyond a threshold, the system will output to the user of the drive an indication that one of the heads is tipping, at block 860. However, prior to outputting an indication to the user the monitoring system 400 can attempt to eliminate the tipping by spinning the disc up again and stopping the disc. This is illustrated at block 856. Then the system 400 rechecks to see if the resistance still exceeds the threshold at block 857. If the resistance still exceeds the threshold then the indication is output at block 860, otherwise the system proceeds as discussed below.

If the height monitoring system 400 is used in a disc drive having multiple heads, the height monitoring system 400 can provide the indication of drive failure, at block 860, if the number of heads that are tipping exceeds a threshold value. For example, in a drive having eight heads, the tipping threshold may be three heads in a tipped state. This threshold can be determined based upon the force required to free the heads from a tipping position versus the force that can be applied or generated by the spindle motor. Generally speaking the threshold value could be the number of tipping heads that can be overcome by the spindle motor minus one. However, other threshold values can be used. Further, when system 400 is used with multiple MRE heads 465 the output can prevent the drive from spinning up to prevent further damage to the data on the disc.

If there was no change in resistance of the MRE head during the stopping process, or the change did not exceed the threshold, the height monitoring system 400 does not generate an output to the user. Prior to the next spin-up cycle of the disc the height monitoring system 400 checks the resistance of the MRE head against the baseline value to verify that the head has not become tipped due prolonged resting on the disc surface. This is illustrated at block 870. If a resistance change is detected the monitoring system 400 repeats step 860.

In conclusion one embodiment of the present invention is directed to a method for detecting head failure of a padded in a disc drive based on the proximity of a MRE head to the surface of the disc. The detection system calculates the resistance of the MRE head in a normal resting position. This value is then stored for use later by the system. During operations a biasing current is applied to the MRE head. This biasing current can be applied prior to disc spin-up or during disc shut down. Next a resistance value of the MRE head is calculated by determining the voltage drop across the MRE head. The resistance of the MRE head is dependent upon its temperature. The temperature of the MRE lowers as its proximity to the disc increases, as the cooler disc surface acts as a conduit drawing heat away from the MRE. This measured resistance value is compared to a threshold value. The threshold value is based upon the resistance of the MRE head at a threshold temperature, which corresponds to a specific distance away from the disc surface. This distance is a height that indicates that head is too close to the surface of the disc. If the measured resistance is lower than the threshold resistance the method outputs an indication to a user that the drive may be in danger of failing. In an alternative embodiment, the method calculates the resistance value for the heads in a disc stack, and provides an output only if a threshold number of the heads exhibit the lowered resistance.

A second embodiment of the present invention is directed towards a system for detecting head failure in a padded slider. The system monitors the height of the MRE head above the disc surface by measuring the resistance of the MRE head during disc spin-up or disc shut down. The MRE head has a resistance that is thermally dependent, and the resistance of the MRE head reduces as the head approaches the surface of the disc due to a cooling effect caused by the disc surface. The system includes a biasing current generator, a voltage measuring component, a processor, and an output component. The biasing current generator is configured to provide a biasing current to the MRE head. This biasing current causes the MRE head to heat, and thus change its resistance. The voltage measuring component is configured to measure a voltage drop across the MRE head in response to the biasing current. The processor is configured to determine the resistance of the MRE head based upon the measured voltage drop, and is configured to compare the resistance with a threshold resistance. The threshold resistance is a resistance that is lower than the resistance of the MRE head when in a normal position. The output component generates an output to a user indicating possible drive failure if the resistance of the MRE is lower than the threshold resistance.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the height monitoring system while maintaining substantially the same functionality without departing from the scope and spirit of the present invention. In addition, although the preferred embodiment described herein is directed to an MRE height monitoring system for detecting head tipping or pad wear, it will be appreciated by those skilled in the art that the teachings of the present invention can be applied to other regimes where the height of the MRE above the disc surface is important, without departing from the scope and spirit of the present invention.

What is claimed is:

1. A method of monitoring height of a magneto-resistive element (MRE) on a padded slider relative to a disc surface during contact start stop operations in a disc drive, comprising the steps of:
a) applying a biasing current to the MRE head;
b) measuring a resistance value of the MRE head at a first temperature;
c) comparing the measured resistance value against a threshold value to produce a comparison output, the threshold value based upon a resistance of the MRE head at a baseline temperature; and
d) outputting an indication of a change in the height based on the comparison output.

2. The method of claim 1 further comprising measuring the resistance value prior to disc spin-up.

3. The method of claim 1 further comprising: (e) prior to step (b) decelerating the disc.

4. The method of claim 3 wherein if the measured value exceeds the threshold value in step (c) executing the steps of:
(f) accelerating the disc back up to a speed;
(g) decelerating the disc again;
(h) remeasuring the resistance value of the MRE head after initiating step (g);
(i) comparing the measured resistance value in step (h) with the threshold value; and
(j) outputting the indication only if the measured resistance again is below the threshold value.

5. The method of claim 4 wherein accelerating in step (f) is executed prior to the disc coming to a complete stop in step (e).

6. The method of claim 1 wherein the disc drive includes a plurality of read/write heads, further comprising:
(e) determining a number of the plurality of read/write heads in the disc drive exceeding the threshold value;
(f) comparing the determined number to a threshold number; and
(g) if the determined number in step (e) exceeds the threshold number, outputting a message that the threshold number was exceeded.

7. The method of claim 6 wherein step (e) is conducted prior to disc spin-up.

8. The method of claim 7 further comprising:
if the determined number exceeded the threshold number, prohibiting the disc drive from spinning up.

9. The method of claim 1 further comprising:
(e) providing the head slider in a normal resting position;
(f) applying a biasing current to the MRE head to heat the MRE head to the baseline temperature;
(g) calculating a normal resistance value for the MRE head in the normal position at the baseline temperature; and
(h) storing the normal resistance value as a baseline value.

10. The method of claim 9 further comprising, setting the threshold value to less than the baseline value.

11. The method of claim 10 wherein setting the threshold value sets the threshold value within 1% of the baseline value.

12. The method of claim 10 wherein setting the threshold value sets a value that indicates head tipping.

13. The method of claim 10 wherein setting the threshold value sets a value that indicates excessive pad wear.

14. The method of claim 1 wherein the temperature of the MRE head is dependent upon the proximity of the MRE head to a disc surface.

15. A monitoring system for monitoring height of a read/write head on a padded slider relative to a disc surface during contact start stop operations in a disc drive, the system including:
a magneto-resistive element (MRE)head, the MRE head having a resistance that is dependent upon a temperature of the MRE head and its proximity to the disc surface;
a biasing current generator configured to provide a biasing current to the MRE head;
a voltage measuring component configured to measure a voltage drop across the MRE head in response to the biasing current;
a processor configured to determine the resistance of the MRE head based upon the measured voltage drop, and is configured to compare the resistance with a threshold resistance; and
wherein the temperature and resistance of the MRE head decreases as its proximity to the disc surface increases.

16. The system of claim 15 wherein the biasing current is less than an operating current of the MRE head.

17. The system of claim 16 wherein the biasing current is less than 10 milliamps.

18. The system of claim 17 wherein the biasing current is less than 5 milliamps.

19. The system of claim 15 further including:
an output component configured to provide an output signal if the resistance of the MRE head is below the threshold resistance.

20. The system of claim 15 wherein the processor stores a baseline resistance value for the MRE, the baseline resistance value being based upon a resistance value of the MRE in a normal position.

21. The system of claim 14 wherein the threshold resistance is a resistance value that is indicative of head tipping.

22. The system of claim 14 wherein the threshold resistance is a resistance value that is indicative of excessive pad wear.

23. A monitoring system for monitoring height of a read/write head on a padded slider relative to a disc surface during contact start stop operations in a disc drive, the system including:
a magneto-resistive element (MRE)head, the MRE head having a resistance that is dependent upon a temperature of the MRE head and its proximity to the disc surface;
a biasing current generator configured to provide a biasing current to the MRE head;
means for determining a change in the height of the MRE head relative to the disc surface by comparing the resistance of the MRE head to a threshold resistance; and
an output component configured to provide an output signal if the resistance of the MRE head is below the threshold resistance.
